(19) United States
(12) Patent Application Publication
(10) Pub. No.: US 2020/0180928 A1
(43) Pub. Date: Jun. 11, 2020

(54) Container Opener

(71) Applicants: Timothy Blackburn, Indianapolis, IN (US); Dustin Ortega, Indianapolis, IN (US); Kadé Diallo, Indianapolis, IN (US); Tyler Cochenour, Bargersville, IN (US)

(72) Inventors: Timothy Blackburn, Indianapolis, IN (US); Dustin Ortega, Indianapolis, IN (US); Kadé Diallo, Indianapolis, IN (US); Tyler Cochenour, Bargersville, IN (US)

(21) Appl. No.: 16/214,046

(22) Filed: Dec. 8, 2018

(51) Int. Cl. B67B 7/16

(52) U.S. Cl. CPC B67B 7/16

(57) ABSTRACT

A container opener that easily pries open sealed containers with a simple twisting action. The lever of the container opener hooks underneath the cap and lifts up the cap as the container opener itself rotates relative to the container. Upon removal of the cap, the container opener reverts back to its original position, releasing the cap.

A method of removing a bottle cap is also disclosed. The method includes placing a base of a container opener on a bottle cap, applying a radial force to the container opener, rotating a cam, latching a follower onto the bottle cap, pulling the follower, applying a prying force to the bottle cap, and removing the bottle cap.

### TECHNICAL FIELD

The invention relates to a container opener; more specifically, related to containers with generic tooth crown cork caps.

### BACKGROUND

This section introduces aspects that may help facilitate a better understanding of the disclosure. Accordingly, these statements are to be read in this light and are not to be understood as admissions about what is or is not prior art.

Beer, soft-drinks and other liquids have commonly been sealed in the past with tooth crown cork caps, otherwise known as bottle caps. Throughout the long existence of bottle caps many methods of removing them have been developed, the simplest of which involve a cavity shaped to encompass the cap and contact both the top of the cap and the bottom lip of the cap. Operation of these devices typically involve a prying motion that deforms the cap in order to break the seal between the bottle and cap and remove the cap from the bottle. Variations of this design include relatively long members that provide sufficient mechanical leverage to remove the cap, the drawbacks of which include size which makes this design impractical for a consumer to carry with them at all times. Another limitation is the inability for individuals with limited dexterity to operate the prior art openers and at the same time comfortably fit in one's pocket or on a keychain. Another prior art approach includes opening bottle caps which are coupled to the bottle via a threaded arrangement to allow a consumer to remove the cap with a twisting motion. This approach presents a drawback requiring a significant force often implemented by a consumer's bare hand against the sharp edges of the metallic cap potentially causing cuts to the consumer.

Therefore, there is an unmet need for a novel approach to remove container caps without the aforementioned limitations of the prior art.

### SUMMARY

A container opener is disclosed capable of opening container caps with a twisting motion. The container cap is released upon the container opener being lifted by the user and the container opener returning to its original position. The container opener comprised of a cam, follower, and base.

A method of removing a bottle cap is also disclosed. The method includes placing a base of a container opener on a bottle cap, applying a radial force to the container opener, rotating a cam, latching a follower onto the bottle cap, pulling the follower, applying a prying force to the bottle cap, and removing the bottle cap

### BRIEF DESCRIPTION OF DRAWINGS

FIG. 1A is an exploded perspective view of a container opener, according to the present disclosure, including a housing assembly, a cam, and a base assembly.

FIG. 1B is a perspective view of a base of the base assembly of FIG. 1A.

FIG. 2 is a perspective view of a follower of the base assembly of FIG. 1A.

FIG. 3 is a perspective view of the cam of FIG. 1A.

FIG. 4 is a perspective view of a housing of the housing assembly of FIG. 1A.

FIG. 5 is a partial exploded view of the base assembly of FIG. 1A.

FIG. 6 is a partial exploded view of the housing assembly of FIG. 1A.

FIG. 7 is a flow chart depicting operation of the container opener, according to the present disclosure.

FIG. 8 is a perspective cutaway view of the container opener of the present disclosure in a starting position.

FIG. 9 is a perspective cutaway view of the container opener of the present disclosure in an ending position.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

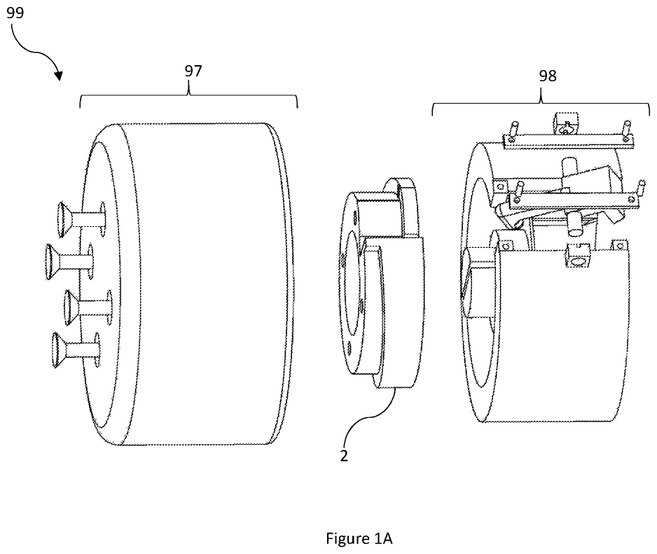

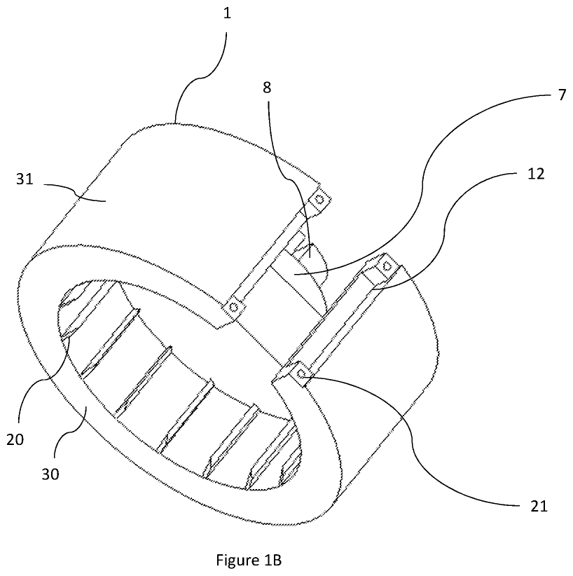

A novel system and method to remove container caps which overcome the aforementioned limitations of the prior art is provided in the present disclosure. FIG. 1A is an exploded perspective view of a container opener 99, according to the present disclosure, including a housing assembly 97, a cam 2, and a base assembly 98. These components when brought together as further described below provide the desired functionalities. Each component is now further described. The housing assembly 97 is mechanically fastened to the cam 2 via a set of fasteners 9 (described below) wherein the cam fastener clearance holes 19 are aligned with the cam fastener holes 18 (as further described below).

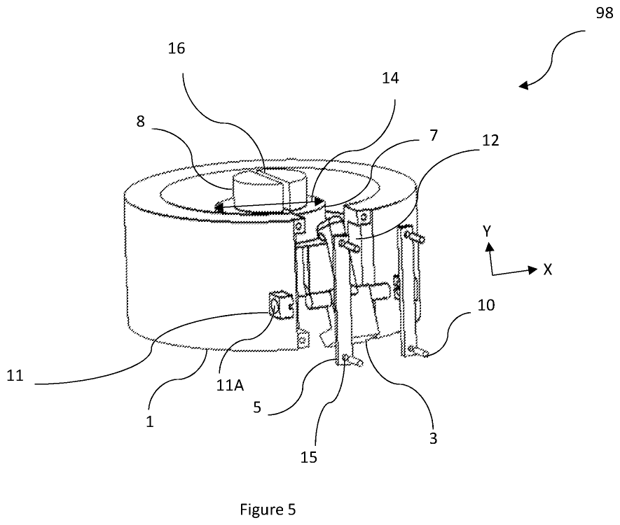

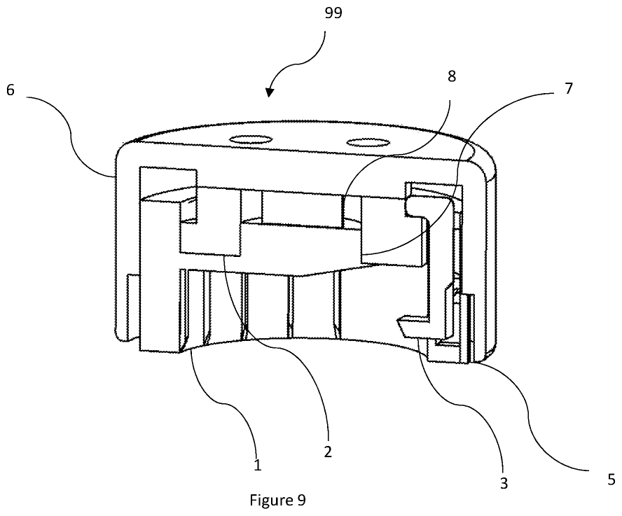

FIG. 1B is a perspective view of a base 1 of the base assembly 98 of the container opener 99. The base 1 has a lower end 30 which has an open cavity with internal extrusions 20 spaced around a circumference defined by the cavity. The internal extrusions 20 are spaced such that the grooves of a bottle cap may fit securely between each extrusion to prevent slippage while the container opener 99 of FIG. 1A is in use. For example, the internal extrusions 20 can number between about 2 to about 20. Each internal extrusion 20 extends from the lower end 30 to a about 50% of the height of the base 1 (see FIG. 9, described below). A bearing surface 7 is defined opposite the lower end 30 within the base 1, under a stem 8. The bearing surface 7 has an operable bearing surface diameter 14 (shown in FIG. 5, discussed further below).

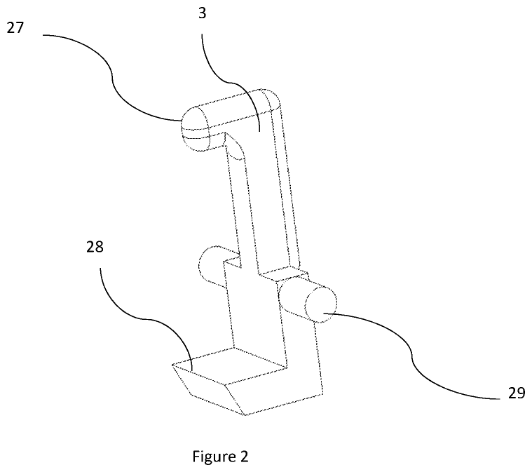

Additionally, the base 1 of FIG. 1B has an opening about an outer surface 31, forming follower slots 12 (only one is called out with a reference number), sufficient in size to accept a follower 3 (shown in FIG. 2). The base 1 has four pin receiving holes 21 at each end of the follower slots 12.

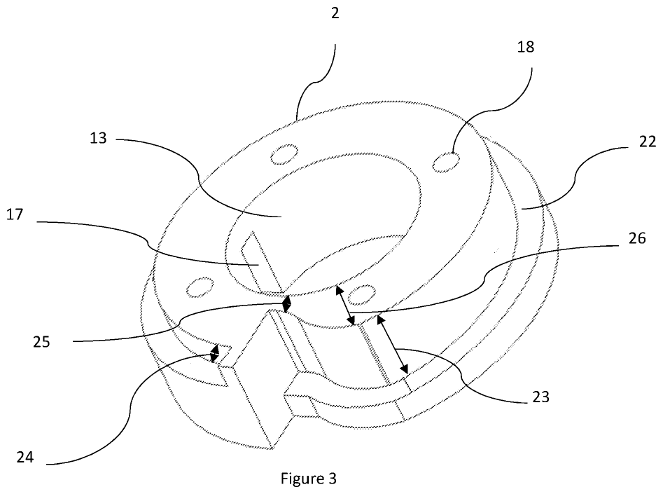

FIG. 2 is a perspective view of the follower 3. The follower 3 is generally an “L” shaped member having an upper portion 27 and a lower portion 28 with cylindrical arms 29 extending out. The follower 3 engages the cam 2 of FIG. 3 by traveling a cam profile 22 (see FIG. 3) during activation of the container opener 99, causing the lower flat portion 28 (see FIG. 3) of the follower 3 to simultaneously engage and remove a bottle cap (not shown). The cylindrical arms 29 on either side of the follower 3 reside within a follower housing 11 (see FIG. 5).

FIG. 3 is a perspective view of the cam 2 including a cam inner diameter 13, a cam slot 17, cam fastener holes 18, the cam profile 22, a cam profile starting height 23, a cam profile ending height 24, a cam profile starting diameter 25, and a cam profile ending diameter 26. The cam profile 22 of the cam 2 changes in diameter around the base of the cam 2 wherein the cam profile starting diameter 25 is smaller than the cam profile ending diameter 26. The height of the cam profile 22 concurrently changes with the diameter of the cam profile 22 such that the cam profile starting height 23 is greater than the cam profile ending height 24. The variation in height and diameter along the cam profile 22 allows the follower 3 (see FIG. 2) to produce the desired motion for removing bottle caps.

The cam inner diameter 13 and the operable bearing surface diameter 14 of the bearing surface 7 are toleranced such that a mating surface generated by contact between these two diameters (13 and 14) provide a sliding fit (i.e., when these surfaces are in contact with one-another, the cam 2 can rotate freely with respect to the bearing surface 7 without slop).

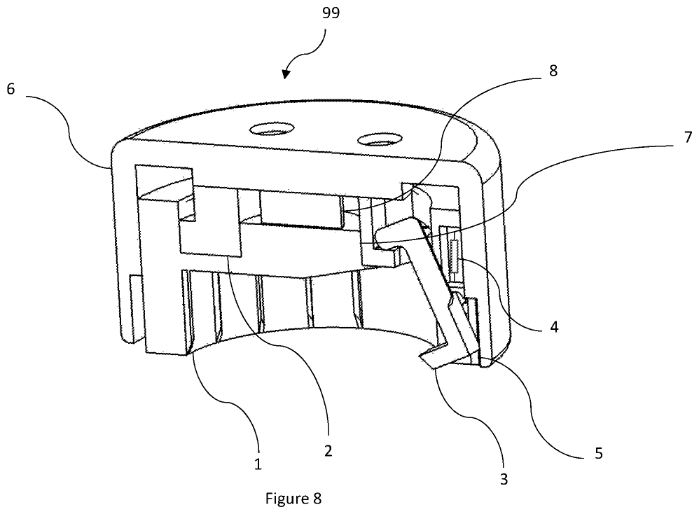

The cam slot 17 of FIG. 3 provides an area for one end of a biasing member 4 to be attached, with the corresponding attachment area for the biasing member 4 (see FIG. 8) located at a stem slot 16 (see FIG. 5) of the base 1. This biasing member 4 positioned between the cam 2 and the base 1 pulls the cam 2 back to its initial starting position following the use of the container opener 99 (as demonstrated between FIGS. 8 and 9).

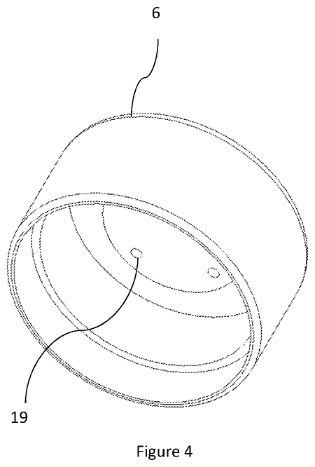

FIG. 4 is a perspective view of a housing 6 of the housing assembly 97 of container opener 99, according to the present disclosure. The housing 6 serves to hold the components of the container opener 99 together within the open cavity by mechanically fastening the cam 2 via a set of cam fastener clearance hole 19, as well as providing the user a means for gripping the mechanism for engagement.

FIG. 5 depicts a partial exploded perspective view of the base assembly 98 including the base 1, the follower 3, the follower retainer 5, a set of pins 10, and a follower housing 11. The cylindrical arms 29 (see FIG. 2) of the follower 3 are placed in the circular openings 11A of the follower housing 11. Once the follower 3 is properly situated within the follower housing 11, the square outer edge of the follower housing 11 is positioned in the follower slots 12 (also see FIG. 2). By aligning the set of pin holes 15 with the set of pin receiving holes 21 on the base 1, the follower retainer 5 is then mechanically fastened to the base 1 via the set of pins 10 thereby fully securing the follower 3 to the base assembly 98. It should be noted that the tolerancing between the follower retainer 5, the follower housing 11, and the follower slots 12 is such that the follower housing 11 is allowed to articulate vertically in the “y” axis. Similarly, the tolerancing between the follower housing 11 and the cylindrical arms 29 of the follow 3 is such that the follower 3 is allowed a rotation degree of freedom about the “x” axis.

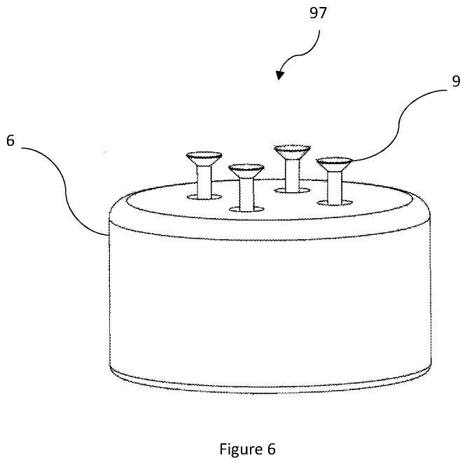

FIG. 6 of the present disclosure illustrates an exploded view of the housing assembly 97 including the housing 6 and a set of fasteners 9. The fasteners 9 are threaded through the cam fastener clearance holes 19 (see FIG. 4) which are aligned with the cam fastener holes 18 (see FIG. 3) to secure the housing 6 to the cam 2. After the housing 6 is mechanically fastened to the cam 2, the complete assembly of the container opener 99 is enclosed and assembled.

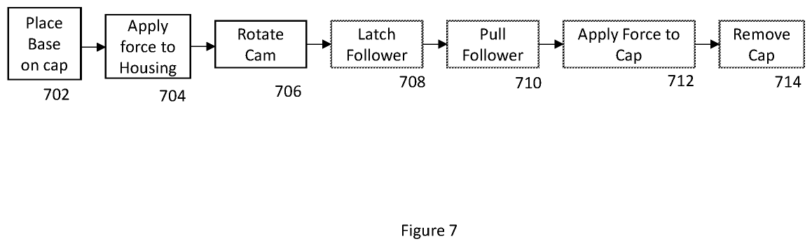

FIG. 7 provides an operational flowchart of the container opener 99 with user input. Once the container opener 99 is fully assembled, the lower end of the base assembly is able to accept a container cap for removal (as shown by the block 702). The end user applies a rotational force to the housing assembly 97 which initiates the rotation of the cam 2 (block 704). As the cam 2 is rotated (block 706), a follower 3 travels along a cam profile 22 of the cam 2. Additionally, as the follower 3 continues to travel along the cam profile 22, the lower flat portion 28 of the follower 3 latches onto the lip of the container cap that is to be removed (block 708). The lower flat portion 28 of the follower 3 concurrently proceeds to pull the container cap upwards (block 710) with a prying motion, providing sufficient force (block 712) to remove the container cap (block 714) from the container of interest. Once the container cap has been removed, biasing members 4 return the container opener 99 to the initial starting position.

FIG. 8 illustrates a cutaway of the starting position for the container opener 99. Once a bottle cap has been placed within the cavity of the base 1, the user can rotate the housing assembly 97 which engages the cam 2 and follower 3. Note that the starting position of the follower 3 is in an open position allowing a bottle cap to be placed within the cavity of the base 1 without obstruction. The upper portion 27 of the follower 3 is in the lowermost position due to the starting orientation of the profile of the cam 2. The follower housing 11 is connected to a biasing member 4 to retract the follower to its initial starting position after completing the use of the container opener 99.

FIG. 9 illustrates a cutaway of the ending position for the container opener 99. After the user has completely rotated the housing assembly 11 which engages the cam 2 and follower 3, the profile of the cam 2 has raised the follower 3 to its uppermost position; thereby engaging the lower, flat portion of the follower 3 with bottle cap by producing a prying motion. The biasing member 4, while not shown in the drawing, is now in a compressed state and will move the follower 3 back to the starting position once the user removes the opened bottle cap.

Those having ordinary skill in the art will recognize that numerous modifications can be made to the specific implementations described above. The implementations should not be limited to the particular limitations described. Other implementations may be possible.

What is claimed is:

1. A container opener, comprising:
a base having a C-shaped partially-hollowed cylindrically shaped opening formed therein, defining an longitudinal opening, the base including a bearing surface and a stem disposed on the bearing surface formed within the partially-hallowed cylindrically shaped opening;
a two-stage cam having a first stage and a second stage and configured to be received in the partially-hollowed cylindrically shaped opening and to interface with a follower coupled to the base, where the first stage is along a first direction from a starting point up to an ending point and the second stage is along a second direction from a starting point up to an ending point, where the second direction is perpendicular to the first direction,
whereby, placement of the base on a bottle cap and application of a radial force along a first radial direction to the cam causes the follower to traverse along the first direction from the starting point to the ending point of the first stage defining a rotational movement, thereby gripping the bottle cap, and continued application of the radial force along the first radial direction causes the follower to traverse along the second direction from the starting point to the ending point of the second stage defining a translational movement, thereby prying the bottle cap.

2. The container opener of claim 1, wherein the base comprises internal extrusions following an inner circumference.

3. The container opener of claim 2, wherein there are at least 2 equally spaced internal extrusions.

4. The container opener of claim 1, wherein the base comprises follower slots disposed on either sides of the opening and configured to allow translational and rotational motion of the follower.

5. The container opener of claim 1, wherein an inner diameter of the cam represents a bearing surface configured to be received by the base bearing surface.

6. The container opener of claim 1, wherein the first stage is defined by an increase in radius along the circumference of the cam.

7. The container opener of claim 1, wherein the second stage is defined by an increase in height throughout the circumference of the cam.

8. The container opener of claim 5, wherein the follower has a top, middle and lower sections.

9. The container opener of claim 8, wherein the top section of the follower is configured to extend towards the cam and interface with the first stage and the second stage, the middle section of the follower is configured to extend towards and interface with the slots, and the bottom section of the follower is configured to extend towards and interface with the bottle cap.

10. The container opener of claim 1, further comprising at least two biasing members.

11. A method of removing a bottle cap, comprising:
placing a base of a container opener on a bottle cap, the container opener comprising
the base having a C-shaped partially-hollowed cylindrically shaped opening formed therein, defining an longitudinal opening, the base including a bearing surface and a stem disposed on the bearing surface formed within the partially-hallowed cylindrically shaped opening;
a two-stage cam having a first stage and a second stage and configured to be received in the partially-hollowed cylindrically shaped opening and to interface with a follower coupled to the base, where the first stage is along a first direction from a starting point up to an ending point and the second stage is along a second direction from a starting point up to an ending point, where the second direction is perpendicular to the first direction, whereby, placement of the base on the bottle cap and application of a radial force along a first radial direction to the cam causes the follower to traverse along the first direction from the starting point to the ending point of the first stage defining a rotational movement, thereby gripping the bottle cap, and continued application of the radial force along the first radial direction causes the follower to traverse along the second direction from the starting point to the ending point of the second stage defining a translational movement, thereby prying the bottle cap;
applying a radial force to the container opener;
rotating the cam;
latching the follower onto the bottle cap;
pulling the follower;
applying a prying force to the bottle cap; and
removing the bottle cap.

12. The method of claim 11, wherein the base comprises internal extrusions following an inner circumference.

13. The method of claim 12, wherein there are at least 2 equally spaced internal extrusions.

14. The method of claim 11, wherein the base comprises follower slots disposed on either sides of the opening and configured to allow translational and rotational motion of the follower.

15. The method of claim 11, wherein an inner diameter of the cam represents a bearing surface configured to be received by the base bearing surface.

16. The method of claim 11, wherein the first stage is defined by an increase in radius along the circumference of the cam.

17. The method of claim 11, wherein the second stage is defined by an increase in height throughout the circumference of the cam.

18. The method of claim 15, wherein the follower has a top, middle and lower sections.

19. The method of claim 18, wherein the top section of the follower is configured to extend towards the cam and interface with the first stage and the second stage, the middle section of the follower is configured to extend towards and interface with the slots, and the bottom section of the follower is configured to extend towards and interface with the bottle cap

20. The method of claim 11, further comprising at least two biasing members.
